(19) United States
(12) Patent Application Publication
(10) Pub. No.: US 2013/0188945 A1
(43) Pub. Date: Jul. 25, 2013

(54) Optical System for Improved FTM Imaging

(71) Applicant: Luc Andre, Grenoble (FR)

(72) Inventor: Luc Andre, Grenoble (FR)

(73) Assignee: COMMISSARIAT A L'ENERGIE ATOMIQUE ET AUX ENERGIES ALTERNATIVES, PARIS (FR)

(21) Appl. No.: 13/824,042

(22) PCT Filed: Sep. 15, 2011
(86) PCT No.: PCT/IB11/54036

§ 371 Date: Mar. 15, 2013

(30) Foreign Application Priority Data
Sep. 17, 2010 (FR) 1003701

(51) Int. Cl. G03B 9/02

(52) U.S. Cl. CPC G03B 9/02
USPC 396/505

(57) ABSTRACT

The invention relates to an optical imaging system comprising: an external lens structure (16,10; 36, 30), with a lens and a substrate; at least one internal lens structure (17, 10; 37, 30), with a lens and a substrate; an image capture structure (110, 310); and a diaphragm (15, 35), characterized in that this diaphragm is located between the lens of the external lens structure and the lens of said at least one internal lens structure and placed away from each of said structures, and in that it is formed in a substrate (10, 30) of a lens structure.

The invention relates to the field of optical imaging systems, in particular obtained by the so-called “Wafer-Level Packaging” technique, that is to say the technology making it possible to assemble integrated circuits on the scale of a wafer.

These imaging systems are intended in particular for cellphones or organizers (or PDA: Personal Digital Assistant). Numerous imaging systems are already known which comprise an image capture element, for example a CMOS sensor, and a stack of optical assemblies, spacers being provided between the optical assemblies and between the image capture element and the stack of optical assemblies.

Thus, the document US-2010/0117176 describes an imaging system comprising a transparent substrate, in particular consisting of glass, on which an aperture lens and a field lens are provided, this substrate being associated with an image capture element.

This optical system comprises an aperture diaphragm which defines the amount of light coming from the scene to be photographed which arrives on the image capture element.

The diaphragm is made from a layer of an opaque material, arranged on the substrate comprising the lenses or, more generally, on the substrate located at the top of the stack if the imaging system comprises a plurality of substrates.

An aperture is formed in this layer of opaque material, in particular by etching. The material used does not transmit light over the visible and near-infrared range, typically from 350 nm to 1000 nm. In practice, this opaque material may be chromium.

It is inside this circular aperture that the aperture lens is formed.

Thus, the light coming from the scene to be photographed passes through the aperture lens then the glass substrate, and finally the field lens located in proximity to the image capture element. The light then propagates through air before being focused onto the image capture element.

In so far as the substrate is transparent, stray light can be captured by the image capture element. This is why it is conventional to provide optical masking around the optical system, so as to reflect or absorb any stray light.

The document US-2009/0253226 may be cited, which describes an imaging system similar to the previous one but in which the diaphragm is defined by a layer of an opaque material which partially covers the aperture lens.

Moreover, the document US-2010/0002314 may also be cited, which describes a system of lenses comprising an internal lens structure and an external lens structure, which are intended to be associated with an image capture element.

Each of these lens structures comprises a transparent substrate, which supports two lenses.

The diaphragm is provided around the lens placed inside the system, on the same substrate as the aperture lens and therefore on the external lens structure. Here again, the diaphragm is defined by an aperture in a layer of light-absorbing material.

According to this document, this arrangement makes it possible to obtain optical symmetry. However, the position and the diameter of the diaphragm depend on the position and the diameter of the lens around which it is provided.

The document JP-2009 300596 illustrates another type of imaging system comprising a stack of opaque substrates. These are pierced with apertures, in which a lens is arranged.

The aperture formed in the substrate located at the top of the stack constitutes the aperture diaphragm of the imaging system.

Furthermore, in this type of imaging system, the stray light is reflected or absorbed by the opaque substrates supporting the lenses. This makes it possible to obviate the optical masking around the stack of substrates.

Thus, in all these imaging systems, the diaphragm of the system is always defined at the periphery of a lens, whether or not it is the aperture lens.

However, it has been found that all these imaging systems have a reduced optical quality and, in particular, a relatively mediocre modulation transfer function. This is the case in particular for VGA (Video Graphics Array) imagers.

Likewise, they have fairly low tolerancing. In particular, poor compliance of the dimensions of the lenses present in the imaging system can have very significant consequences on the final performance.

It is therefore an object of the present invention to provide an imaging system in which the optical quality can be optimized, by virtue of an improvement in the modulation transfer function, together with the maintenance of low distortion.

Thus, the invention relates to an optical imaging system comprising:
an exterior lens structure, with a lens and a substrate,
at least one interior lens structure, with a lens and a substrate,
an image capture structure,
said at least one interior lens structure being located between the exterior lens structure and the image capture structure and
a diaphragm, characterized in that this diaphragm is located between the lens of the exterior lens structure and the lens of said at least one interior lens structure and at a distance from each of them, and in that it is formed in a substrate of a lens structure.

Consequently, in an optical imaging system according to the invention, the diaphragm and its position inside the system are defined independently of the position of the lens structures and therefore of the substrates and the lenses of these lens structures.

In other words, an optical imaging system according to the invention can be designed with an additional degree of freedom, compared with the known systems which systematically provide the diaphragm at the periphery of a lens and therefore on a substrate of a lens structure.

This is because, in conventional optical imaging systems, the only degrees of freedom available for optimizing the optical quality are the positioning of the lenses with respect to one another and the aspherization of the lenses, the distance between the first lens (that is to say the one located furthest out) and the image capture structure and the indices of the materials used.

As will be shown below, this additional degree of freedom makes it possible to produce optical imaging systems in which the diaphragm is expediently positioned between the two lenses, for example symmetrically, which makes it possible to eliminate certain aberrations (coma, distortion, lateral chromatism), while permitting less stringent tolerancing.

This additional degree of freedom thus makes it possible to design optical systems having technical characteristics superior to those of conventional optical systems.

Thus, an optical imaging system according to the invention makes it possible to improve the parameters defining the quality of the system: its modulation transfer function is improved and the distortion is less.

The substrate in which the diaphragm is formed may, in particular, be opaque.

Advantageously, the lens structures and the diaphragm are located in the same substrate.

In this case, the substrate is preferably obtained by molding an opaque plastic material.

In a particular embodiment, a layer of an absorbent material is provided around the diaphragm.

Advantageously, the diameter of the diaphragm lies between 0.05 mm and 5 mm.

The invention will be better understood, and other objects, advantages and characteristics thereof will become clearer, on reading the following description which is given with reference to the appended drawings, in which:

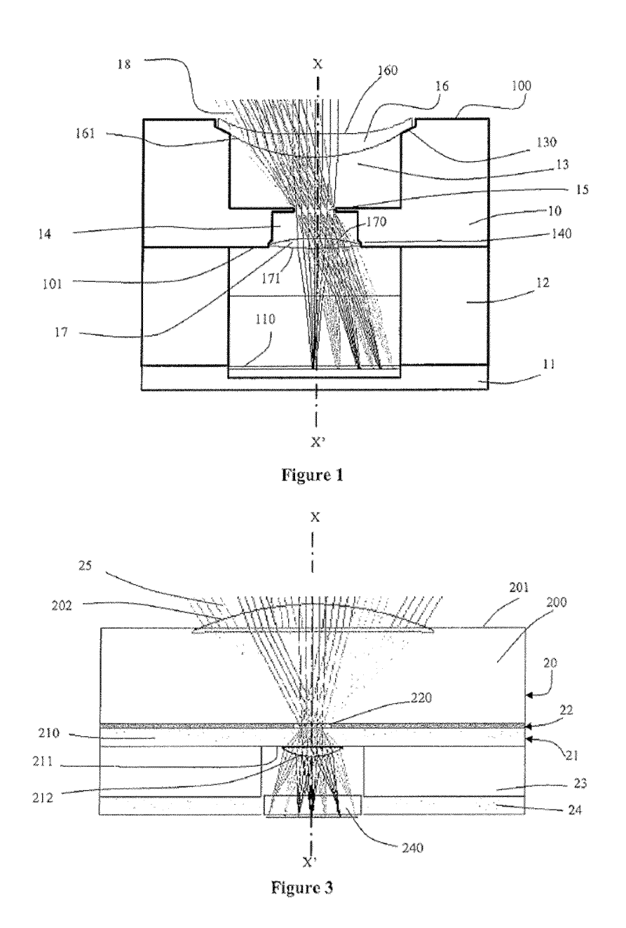

FIG. 1 is a view in section of a first example of an optical imaging system according to the invention, made from a silicon substrate,

FIG. 2 schematically illustrates various steps in the production of a system of the type illustrated in FIG. 1 (FIGS. 2a to 2p),

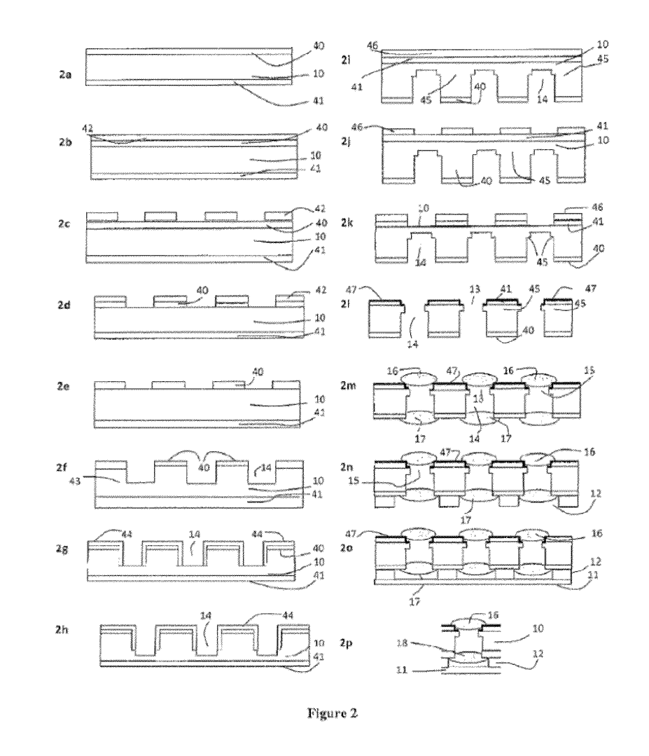

FIG. 3 is a view in section of a second exemplary embodiment of an optical imaging system according to the invention, made from glass substrates,

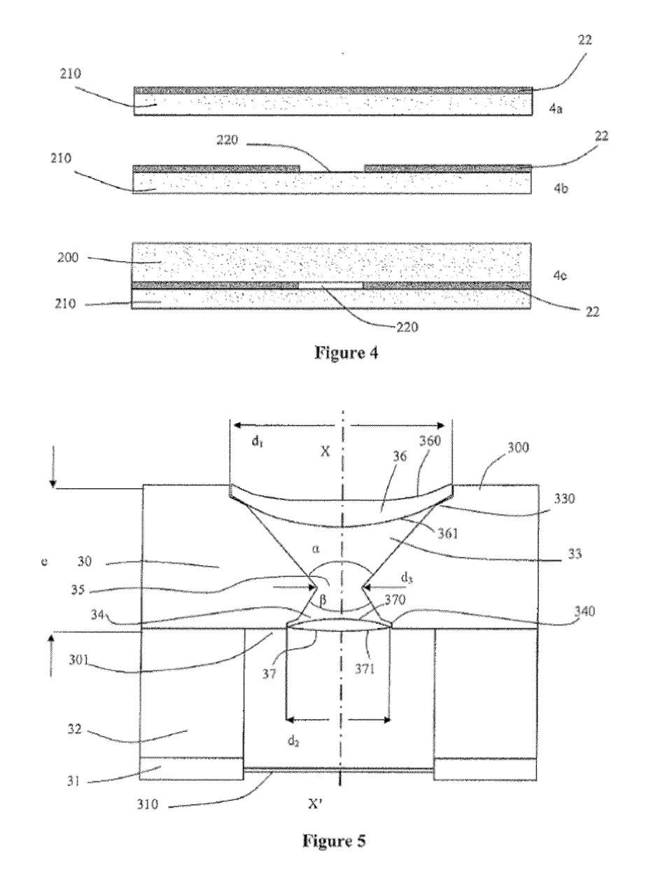

FIG. 4 comprises FIGS. 4a to 4c, which illustrate various steps in a method for obtaining the system illustrated in FIG. 3 and

FIG. 5 illustrates a third exemplary embodiment of an optical imaging system according to the invention, obtained by molding an opaque plastic material.

The elements common to the various figures are denoted by the same references.

FIG. 1 illustrates an optical imaging system comprising a substrate 10 with two lens structures, a substrate 11 on which the image capture element 110 is formed, such as a CMOS sensor, and a spacer 12 between the two substrates 10 and 11.

Generally, throughout the description, the term “lens structure” means a single lens associated with a substrate.

The substrate 10 is in particular a silicon substrate in which a through-orifice has been formed, the shape of which is determined by the lens structures to be produced and by the dimensions of the diaphragm.

In the example illustrated in FIG. 1, this through-orifice is formed by two cavities 13 and 14 which have different radial dimensions and are centered on the axis XX′.

The diaphragm 15 is defined between these two cavities 13 and 14.

Thus, the substrate 10 comprises a substantially cylindrical first cavity 13 which opens outside the imaging system and comprises a widening 130 in proximity to the exterior face 100 of the substrate.

A first lens 16, or aperture lens, is formed at the widening 130. Together with the upper part of the substrate 10, it forms an exterior lens structure. This lens is concave and comprises an external optical interface 160 and an internal optical interface 161.

The substrate 10 also comprises a substantially cylindrical second cavity 14 which, in turn, opens onto the internal face 101 of the substrate 10.

This cavity 14 comprises a widening 140 in proximity to the interior face 101 of the substrate.

In the example illustrated in FIG. 1, the radial dimension of the cavity 14, that is to say as considered from the axis XX′ constituting the optical axis of the system, is less than the radial dimension of the cavity 13.

A lens 17 is formed at the widening 140. Together with the lower part of the substrate 10, it forms an interior lens structure. This lens is convex and comprises an external optical interface 170 and an internal optical interface 171.

The diaphragm 15 is constituted by an aperture, formed in the substrate 10, between the two cavities 13 and 14.

The radial dimension of the aperture 15 is less than the radial dimensions of the cavities 13 and 14.

In the exemplary embodiment illustrated in FIG. 1, the substrate consists of silicon, and the diaphragm can therefore be defined by a simple aperture in the substrate.

Nevertheless, the optical system according to the invention could also comprise a layer of an absorbent material arranged at the periphery of the aperture 15.

This absorbent layer could, for example, be made of tungsten or TiN.

FIG. 1 also schematically illustrates the path of the light 18 coming from a scene to be photographed.

The light is initially deflected by the external lens 16.

It subsequently propagates through air as far as the aperture 15; this is where the amount of light incident on each pixel of the sensor 110 is defined. Thus, the larger the diameter of the aperture is, the greater is the amount of light received on the sensor 110.

After having passed through the aperture plane 15, the light propagates as far as the internal lens 17 where it is again deflected, so as to be focused into the plane of the sensor 110.

FIG. 2 illustrates an example of a method for the production of the optical imaging system of the type illustrated in FIG. 1, obtained from a silicon substrate.

FIG. 2a illustrates a first step of this method, in which a layer 40, 41 of SiO₂ is deposited on each side of a silicon substrate 10.

These SiO₂ layers constitute a hard mask. The next step, illustrated in FIG. 2b, consists in depositing a sacrificial layer 42, typically of resin, on the layer 40.

A photolithography step is then carried out on the layer 42 (FIG. 2c).

The next two steps, illustrated in FIGS. 2d and 2e, consist in etching the layer 40 then removing the rest of the sacrificial layer 42.

FIG. 2f illustrates a step of etching the silicon substrate 10. This etching takes place over a part of the thickness of the substrate 10, so as to create a series of holes 14.

FIG. 2g illustrates a step during which a sacrificial layer 44 is deposited around the holes 14 and on the walls of these holes. The material used may be a resin such as JSR1782 or TOK7052 or tungsten.

Another step of etching the silicon substrate 10 is then carried out (FIG. 2h).

The etching is carried out over a part of the thickness of the substrate 10, and the sacrificial layer 44 is then removed.

FIG. 2i illustrates the element of FIG. 2h turned over. It shows that steps 2g and 2h have made it possible to form a wider base 45 at the bottom of the holes 14.

This same FIG. 2i shows another step of the method, consisting in depositing another sacrificial layer 46 on the SiO₂ layer 41. This layer 46 may be made of a material such as JSR1782 or TOK7052.

FIGS. 2j and 2k illustrated steps of photolithography of the layer 46 and etching of the SiO₂ layer 41, which are similar to the steps, illustrated in FIGS. 2c and 2d, carried out on the layer 40.

The layer 46 is then fully removed, in a step similar to the step illustrated in FIG. 2e.

The step 2l consists in etching the silicon substrate 10 again, which makes it possible to make the holes 14 into through-holes, the substrate 10 being eliminated in extension of the holes in order to form a cavity 13.

A layer of absorbent material 47 is then deposited on the layer 41 present on the substrate. This step is optional.

It will be noted that, after step 2l, a series of cavities 13 and 14 are defined in the substrate 10, which communicate with one another and are separated by a narrowing consisting of two adjacent bases 45.

The next step (FIG. 2m) consists in producing a lens 16 in each cavity 13 and a lens 17 in each cavity 14, the free space between two adjacent bases 45 constituting a narrowing forming a diaphragm 15.

Step 2n consists in depositing spacers 12 under the substrate, and step 2o consists in associating a substrate 11, on which image capture elements are produced, with the spacers 12.

An optical system according to the invention is subsequently obtained by cutting (step 2p). It differs from that illustrated in FIG. 1 by the dimension of the cavities and by the shape of the lenses.

Thus, FIGS. 1 and 2 show that this optical imaging system according to the invention comprises a diaphragm which is located between the exterior lens structure and the interior lens structure, while being separated from each of these structures. It is thus located between the lenses of the exterior and interior structures and at a distance from each of these lenses.

In other words, the diaphragm is no longer located at the periphery of the lens or substantially in its plane, but conversely at a distance from each of the lenses.

In general, the thickness of the substrate 10, that is to say its dimension along the axis XX′, lies between 0.3 mm and 3 mm and the diaphragm may be positioned at a level lying between 20 and 80% of the thickness of the substrate.

By way of example, the thickness of the substrate 10 is of the order of 0.974 mm, the distance between the diaphragm and the internal optical interface 161 of the aperture or exterior lens 16 is 0.650 mm, and the distance between the diaphragm and the internal optical interface 171 of the field or interior lens 17 is 0.320 mm.

Consequently, the diaphragm can be positioned at any location in the optical system, and not necessarily at the same level as one of the lens structures.

It is thus that an additional degree of freedom is obtained when designing the optical system. This design follows the steps below, on the basis of specifications as summarized in Table 2 mentioned below and for an optical system comprising two lenses:
In a first design step, a reduced part)(5° of the field is considered. The radii of curvature of the lenses are defined so as to obtain the focal length indicated.
One of the conventional principles of optical system design consists in positioning the aperture diaphragm at an equal distance between the two lenses, which makes it possible to obtain systems having low aberrations.
In a second step, the field is increased to 30°, corresponding to the specifications. Increasing the field introduces new aberrations. These aberrations are corrected on the one hand by aspherizing the exterior optical interfaces, and on the other hand by departing from the initial symmetry of the system and positioning the diaphragm in a suitable way.

This makes it possible to improve the performance of the system.

FIG. 3 illustrates another example of an optical imaging system according to the invention, made with transparent substrates and in particular glass substrates.

Thus, this optical system comprises an exterior lens structure 20 and an interior lens structure 21, which are separated by a layer of an opaque material 22 in which the diaphragm 220 is formed.

This optical system also comprises a substrate 24 on which an image capture element 240 is formed, such as a CMOS sensor, and a spacer 23 located between the internal lens structure 21 and the substrate 24.

The exterior lens structure 20 is formed on a glass substrate 200 which, on its exterior face 201, comprises a lens 202. The internal lens structure 21 also comprises a glass substrate 210 and a lens 212 formed on the interior surface 211 of the substrate 210.

The two lenses 202 and 212 are centered on the axis XX′ of the optical system.

As in the example illustrated in FIG. 1, the lens 202, or aperture lens, is wider than the lens 212, or field lens. The invention is not limited to this exemplary embodiment, and in certain cases the field lens could be wider than the aperture lens. This depends broadly on the design rules and the optimization methods used during the design of the optical system.

Likewise, in the example illustrated in FIG. 3 the two lenses 202 and 212 are planoconvex, although the invention is not limited to this embodiment. Each lens could also be concave, the selection of the lenses depending essentially on the characteristics of the final optical system.

Between its two substrates 200 and 210, a layer of an opaque material 22 is provided, in which the aperture 220 is formed. The latter is centered on the axis XX′ of the optical system. The layer 22 may be made of any opaque material, and in particular of chromium, or alternatively tungsten or TiN which are less reflective than chromium.

FIG. 3 schematically illustrates the path of the light 25 coming from the scene to be photographed.

The light 25 is thus deflected by the external lens 202, before propagating through the glass substrate 200 as far as the absorbent layer 22, in which the aperture 220 is defined.

After having passed through this aperture 220, the light propagates through the glass substrate 210 as far as the internal lens 212.

It is deflected again there, so as to be focused into the plane of the sensor 240.

Here again, the diaphragm 220 is located between the two lens structures, or between the two lenses 202 and 212, and at a distance from each of them.

The position of the diaphragm inside the optical system can therefore be determined independently of the positioning of the lenses, in particular by modifying the thickness of one or other of the glass substrates 200 or 210. This makes it possible to design an optical system which is symmetrical with respect to the diaphragm.

Reference is now made to FIG. 4, which illustrates the steps of a method for producing the optical system illustrated in FIG. 3.

FIG. 4a illustrates a first step of this method, in which a layer 22 of an absorbent material is formed on the glass substrate 210.

The thickness of the absorbent layer may vary from a few tens of nanometers to 10 micrometers.

FIG. 4b illustrates a step during which the aperture 220 is formed in the layer 22.

The etching of a layer of chromium, tungsten or TiN may be carried out by the so-called RIE (Reactive Ion Etching) technique, after a conventional lithography step.

FIG. 4c illustrates another step, in which the glass substrate 200 is adhesively bonded onto the layer of opaque material 22.

The adhesive bonding may in particular be carried out by using a UV-curable polymer adhesive.

In order to obtain the optical system illustrated in FIG. 3, it is more suitable to attach the substrate 24, on which the sensor 240 is produced, by interposing a spacer 23 between the glass substrates and the substrate 24.

Reference is now made to FIG. 5, which illustrates another exemplary embodiment of the optical imaging system according to the invention.

This system comprises a substrate 30 with two lenses, a substrate 31 on which the image capture element 310 such as a CMOS element is formed, and a spacer 32 between the two substrates 30 and 31.

The substrate 30 comprises a through-orifice, formed by two cavities 33 and 34 in the form of inverted cones which are centered on the axis XX′ of the system.

In the example illustrated in FIG. 5, the aperture angle α of the frustoconical cavity 33 is greater than the aperture angle β of the frustoconical cavity 34.

The cavity 33 opens outside the imaging system and comprises a widening 330 in proximity to the exterior face 300 of the substrate.

A first lens 36 is formed at the widening 330. This lens is convex and comprises an exterior optical interface 360 and an interior optical interface 361. Together with the upper part of the substrate 30, it forms an exterior lens structure.

The cavity 34 opens onto the internal face 301 of the substrate 30. It may also comprise a widening 340 in proximity to the interior face 301 of the substrate.

A lens 37 is formed at the widening 340. It is concave and comprises an exterior optical interface 370 and an interior optical interface 371. Together with the lower part of the substrate, it forms an internal lens structure.

A diaphragm 35 is defined between the two conical cavities 34 and 35. It therefore constitutes a constriction in the through-orifice of the substrate 30, in view of the arrangement of the two cavities as inverted cones.

Thus, the radial dimension of the aperture 35 is less than the radial dimensions of the cavities 33 and 34.

In the exemplary embodiment illustrated in FIG. 5, the substrate 30 is preferably obtained by molding a piece made of an opaque plastic material.

This opaque plastic material may be a material such as liquid-crystal polymer, polysulfone or polyether sulfone, including glass or carbon fibers. The percentage by mass of the glass or carbon fibers lies between 10 and 35%, depending on the degree of opacity desired, and it is typically 30%.

All these polymers withstand high temperature rises well. It may for instance be noted that the thermal expansion coefficient of polysulfone is 0.6.10⁻⁵/° C. and that of polyether sulfone is 0.8.10⁻⁵/° C.

Preferably, the plastic material used will be opaque over the visible band and over the near-infrared band, that is to say over a wavelength range extending from 350 nm to 1000 nm.

The opacity will be considered satisfactory if the light transmission is less than 0.1% over this spectral range.

Furthermore, in order to contribute to improving the optical quality of the system according to the invention, a plastic material will preferably be selected whose behavior is comparable to that of the silicon in which the substrate 31 is formed.

In particular, its thermal expansion coefficient will be selected close to 3.10⁻⁶/° C.

This is because if the various substrates present in the optical system have different thermal expansion coefficients, then during a rise in temperature the expansion differences are liable to cause stack deformations, in the form of cracking or delamination. They also lead to noncompliance with the mechanical dimensions. This can therefore degrade the optical quality of the system.

The optical system illustrated in FIG. 5, obtained with a molding method, requires a reduced number of steps compared with the system illustrated in FIG. 1. It therefore necessarily has a reduced cost.

In general, when the substrate used is silicon, the cavities formed therein will advantageously have straight sides, as illustrated in FIG. 1.

When the substrate is a molded plastic material, the cavities will advantageously have inclined walls because this facilitates the mold release.

Furthermore, the lenses of the optical systems illustrated in the various figures may be obtained by depositing a drop of a thermally curable polymer, for example a polycarbonate, or a UV-curable polymer.

This material is, of course, transparent over the visible range 400 nm-700 nm.

The polymer is then cured by heating or by UV exposure.

Furthermore, before the polymerization, a mold may be put in place in order to shape the polymer drops and it is held in place throughout the polymerization time.

The profile of the mold is generally defined as a function of the distance from the optical axis, by an equation whose parameters are the radius of curvature, the conicity and the aspherization coefficients.

Depending on the profile selected, an aperture lens (high conicity, low aspherization) or a field lens (low conicity, high aspherization) may, for example, be produced.

The polymer materials typically used for producing the lenses are PMMA (polymethyl methacrylate), polycarbonate or polyurethane polymers.

Furthermore, all the optical systems described above comprise only two lenses. The invention is not, however, limited to these embodiments. In fact, optical systems of the 1.3 or 5 megapixel type will comprise more than two lenses. In these, there may be any positioning of the diaphragm with respect to each of these three lenses, so long as it is separated from each of them. The positioning will be defined following an optical design step.

An example of the dimensioning of an optical system according to the invention will now be given. This example is a VGA imaging system for cellphones.

This system comprises a substrate consisting of opaque plastic material or silicon, the thickness of which may vary from a few tens of microns to several millimeters. It typically lies between 0.3 and 3 mm.

This substrate is pierced with a through-orifice, each end of which can receive a lens.

The diameter of the diaphragm may vary between 0.05 mm and 5 mm, and it is typically 0.42 mm.

Furthermore, the thickness of the substrate at the diaphragm will in particular lie between 100 μm and 1 mm.

It may be noted that, with a substrate consisting of opaque plastic material, it is not expedient to provide an absorbent layer because it is black and therefore absorbs light well. For a silicon substrate, this absorbent layer may be provided around the aperture lens, depending on the absorption, the transmission and the reflection of the silicon.

More precisely, the following dimensioning may be selected.

The thickness e of the substrate 30 is 0.974 mm.

The thickness of the substrate at the diaphragm is 0.309 mm.

The greatest diameter of the cavity 33 (d₁) is 1.73 mm, that of the aperture 34 (d₂) is 0.944 mm, while the diameter of the aperture 35 (d₃) is 0.426 mm.

Furthermore, the angle α is 45° and the angle β is 38.8°.

This dimensioning is selected for lenses 36 and 37 whose interior optical interfaces are spherical, the internal optical interface 361 of the exterior lens being placed at a distance of 0.652 mm from the aperture 35, while the internal optical interface 371 of the interior lens is placed at a distance of 0.322 mm from the aperture 35.

This arrangement makes it possible to limit the coma aberrations, the distortion and the transverse chromatic aberrations.

Furthermore, in order to optimize the optical quality of the system, it is suitable to define the radii of curvature of each of the optical interfaces, the aspherization parameters of the exterior optical interfaces of each of the lenses, as well as the height of each of the cavities defined in the substrate and the positioning of the substrate 30 with respect to the plane of the sensor 31.

In particular, an optical interface may be described by an equation z=f(r), z being the height of the optical interface at the coordinate r. This function may take several forms, for example the following parameterized form:

$$z = \frac{1}{R} \times \frac{{r}^{2}}{1 + \sqrt{1 - ( 1 + k ) \cdot \frac{{r}^{2}}{{R}^{2}}}} + {α}_{1} \cdot {r}^{2} + {α}_{2} \cdot {r}^{4} + {α}_{3} \cdot {r}^{6} + {α}_{4} \cdot {r}^{8} ,$$

with
R radius of curvature of the optical interface (mm)
k conicity of the shape (no units)
r radius (in mm) r=0 at the center, on the optical axis
α₁(mm-1) 1^{st} order coefficient
α₂(mm-3) 2^{nd} order coefficient
α₃(mm-5) 3^{rd} order coefficient
α₄(mm-7) 4^{th} order coefficient.

Table 1 below gives some dimensioning examples.

| | | | | k Conicity of | | | | |
|---|---|---|---|---|---|---|---|---|
| | R Radius of | Thickness | | the shape of | | | | |
| | curvature of | of the | Half | the optical | | | | |
| | the optical | optical | diameter | interface | | | | |
| | interface | interface | of the lens | (dimension- | α₁ | α₂ | α₃ | α4 |
| | (mm) | (mm) | (mm) | less) | (mm − 1) | (mm − 3) | (mm − 5) | (mm − 7) |
| optical interface | −5 | 0.29 | 1.191 | 18.828 | 0 | −0.116 | 0.045 | 0 |
| 360 | | | | | | | | |
| optical interface | −1.687 | 1.018 | 1.185 | 0 | 0 | 0 | 0 | 0 |
| 361 | | | | | | | | |
| optical interface | 1.687 | 0.16 | 0.498 | 0 | 0 | 0 | 0 | 0 |
| 370 | | | | | | | | |
| optical interface | −1.299 | 1 | 0.511 | −26.867 | 0 | −0.64 | 1.616 | 0 |
| 371 | | | | | | | | |

The values given in this table make it possible to describe the optical interfaces characteristic of the lenses, but also the air space between each of them. Thus, the thickness of the optical interface 361 (1.018 mm) defines the distance along the optical axis between the top of the optical interface 361 and the aperture diaphragm, and the thickness of the optical interface 371 defines the distance along the optical axis between the top of the optical interface 371 and the sensor 310.

Furthermore, the thickness of the optical interface 360 or 370 corresponds to the thickness of the lens 36 or 37.

The advantages of the optical system according to the invention will now be illustrated with the aid of comparative measurements between two optical imaging systems, one according to the prior art and the other according to the invention.

An optical system according to the prior art is intended to mean an optical system comprising an external lens structure, an internal lens structure and an image capture element, in which the diaphragm is formed at the periphery of the aperture lens of the external system, using a layer of opaque material. Furthermore, an optical system according to the invention is intended to mean a system corresponding to that illustrated in FIG. 5, the dimensioning of which also corresponds to the example mentioned above.

These two optical systems are theoretically designed to produce a VGA imager whose specifications are summarized in Table 2 below.

| Parameters | Units | Value |
|---|---|---|
| Type of sensor | | VGA |
| number of pixels | | 640 × 480 |
| number of pixels in x | | 640 |
| number of pixels in y | | 480 |
| Size of the pixels | μm | 1.72 |
| Spectral range | nm | 400 nm-700 nm |
| Numerical aperture | | 2.8 |
| Field | ° | 30 |
| MTF | cycles/mm | 50% at 73 cycles/mm |
| Distortion | % | <1% |
| Relative illumination at | % | >65% |
| 80% FOV | | |
| Telecentricity | ° | <30° |
| Focal length of the optical | mm | 0.85 |
| system | | |

The measurements carried out for the two optical systems compared relate to the modulation transfer function (MTF) and the distortion.

The modulation transfer function gives the resolving power of the optical system, that is to say the capacity of a system to distinguish two or more consecutive white lines on a black background.

The measurement is carried out on the basis of a test chart, that is to say a plurality of consecutive white lines on a black background, which is characterized by a spatial repetition frequency. The modulation transfer function is determined by measuring the contrast of these white lines, as a function of the spatial frequency characterizing them.

For the two optical systems, the modulation transfer function is given for a frequency in lines per millimeter ranging from 0 to 73 lpm and for a field varying from 0° to 30°.

The measurements carried out show that the MTF is 20% for the optical system according to the prior art and 57% for the optical system according to the invention. These two values are given for a field of 30° and a frequency in lines per millimeter of 73 lpm. Thus, the optical system according to the prior art does not fulfill the conditions set by the specifications. Conversely, the value of 57% is satisfied for the optical system according to the invention for a field varying from 0° to 30° and for an MTF varying from 0 to 73 lpm.

The distortion is the second of the most important parameters in the characterization of an optical imaging system.

The distortion is a measure of the deformation of the image, the magnification thereof possibly not being identical at all points of a sensor.

The measurements carried out for the optical system according to the prior art and that according to the invention show that the distortion is less than 1% for both systems, and therefore compliant with the specifications.

In conclusion, these comparative measurements make it possible to show that an optical system according to the invention allows the modulation transfer function to be improved substantially while maintaining low distortion.

Thus, optical systems according to the invention may be envisaged which have a more extended field and/or a reduced aperture, with a modulation transfer function comparable to those of conventional optical systems.

Indeed, it may be beneficial to provide cameras with a larger field or with shorter exposure times, in order to avoid the problems of image stabilization.

The reference signs inserted after the technical characteristics appearing in the claims are merely intended to facilitate comprehension thereof, and do not limit their scope.

1. An optical imaging system comprising:
an exterior lens structure, with a lens and a substrate,
at least one interior lens structure, with a lens and a substrate,
an image capture structure and
a diaphragm, characterized in that this diaphragm is located between the lens of the exterior lens structure and the lens of said at least one interior lens structure and at a distance from each of them, and in that it is formed in a substrate of a lens structure.

2. The system as claimed in claim 1, wherein said substrate is opaque.

3. The system as claimed in claim 2, wherein the lens structures and the diaphragm are located in the same substrate.

4. The system as claimed in claim 2, wherein the substrate is obtained by molding an opaque plastic material.

5. The system as claimed in claim 2, wherein a layer of an absorbent material is provided around the diaphragm
